(19) United States
(12) Patent Application Publication
(10) Pub. No.: US 2024/0191334 A1
(43) Pub. Date: Jun. 13, 2024

(54) STRUCTURE

(71) Applicant: Nippon Telegraph and Telephone Corporation, Tokyo (JP)

(72) Inventors: Shota Oki, Tokyo (JP); Shingo Mineta, Tokyo (JP); Mamoru Mizunuma, Tokyo (JP); Soichi Oka, Tokyo (JP)

(21) Appl. No.: 18/553,782

(22) PCT Filed: May 13, 2021
(86) PCT No.: PCT/JP2021/018174

§ 371 Date: Oct. 3, 2023

(51) Int. Cl. C23C 8/72; C23F 11/14

(52) U.S. Cl. CPC C23C 8/72; C23F 11/149

(57) ABSTRACT

A structure member includes a base formed of metal and a repair layer built in the base. The repair layer includes a plurality of capsules dispersed on the same plane, and a liquid repairing agent is enclosed in the capsules. The repair layer is disposed substantially parallel to a surface on which the structure member is exposed to the outside air. In addition, the repair layer can be disposed at a depth X set from a surface on which the structure member is initially exposed to the outside air. The capsule is formed of a material that breaks when exposed from the base.

### CROSS-REFERENCE TO RELATED APPLICATIONS

This patent application is a national phase entry of PCT Application No. PCT/JP2021/018174, filed on May 13, 2021, which application is hereby incorporated herein by reference.

### TECHNICAL FIELD

The present invention relates to a structure member including a base made of a metal.

### BACKGROUND

When a structure member made of a metal is exposed to a natural environment for a long period of time, its thickness decreases due to corrosion. Due to this corrosion phenomenon, deterioration of the metal structure member progresses to decrease durability (Non Patent Literature 1). In the approximately 20 years since the high economic growth period, social infrastructure in Japan has been developed in a large amount and rapidly, and thus there is a concern that the number of aging facilities can be expected to further increase in the future.

In order to maintain the safety and the security of these metal facilities that support social infrastructure, it is important to ascertain the deterioration states of the facilities and to maintain the facilities appropriately according to the ascertained deterioration states. In performing maintenance of these metal facilities, it is necessary to accurately determine how much the used base has deteriorated. In addition, regarding the maintenance method, it is expected to reduce the life cycle cost by grasping the type of metal material used for each facility and performing repair or the like according to the material.

### CITATION LIST

### Non Patent Literature

Non Patent Literature 1: Y. Wan et al., “Corrosion Behaviors of Q235 Steel in Indoor Soil”, International Journal of Electrochemical Science”, vol. 8, pp. 12531-12542, 2013.

### SUMMARY

### Technical Problem

Incidentally, when the deterioration state of a metal structure member is checked, maintenance for extending the life is performed for facilities in which corrosion recession is severe, but a large amount of equipment is required depending on a repair method, so that many personnel need to be dispatched to the site, and there is a concern about an increase in cost. As described above, conventionally, there has been a problem that maintenance of the metal structure member cannot be performed at low cost.

Embodiments of the present invention have been made to solve the above problems, and an object of embodiments of the present invention is to enable maintenance of a metal structure member to be performed at low cost.

### Solution to Problem

A structure member according to embodiments of the present invention includes a base formed of metal, and a repair layer built in the base, in which the repair layer includes a plurality of capsules dispersed on the same plane, a liquid repairing agent is enclosed in the capsule, and the capsule is formed of a material which is broken by being exposed from the base.

### Advantageous Effects of Embodiments of the Invention

As described above, according to embodiments of the present invention, since the repair layer incorporated in the base is provided, the maintenance of the metal structure member can be performed at low cost.

### BRIEF DESCRIPTION OF THE DRAWINGS

FIG. 1 is a perspective view illustrating a configuration of a structure member according to an embodiment of the present invention.

FIG. 2 is a perspective view illustrating a configuration of the structure member according to an embodiment of the present invention.

FIG. 3 is a perspective view illustrating a configuration of the structure member according to an embodiment of the present invention.

FIG. 4 is a perspective view illustrating a configuration of another structure member according to an embodiment of the present invention.

### DETAILED DESCRIPTION OF ILLUSTRATIVE EMBODIMENTS

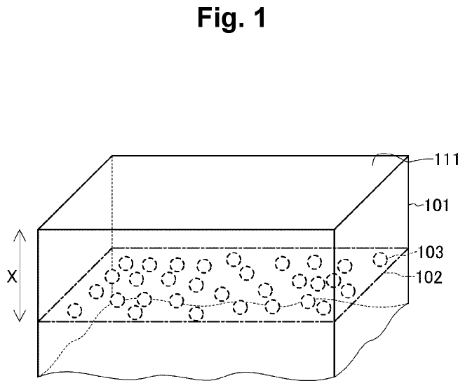

A structure member according to an embodiment of the present invention will be described below with reference to FIG. 1. A structure member includes a base 101 formed of metal and a repair layer 102 built in the base 101. The repair layer 102 includes a plurality of capsules 103 dispersed on the same plane, and a liquid repairing agent is enclosed in the capsules 103.

The repair layer 102 can be built in an arbitrary position inside the base 101. The repair layer 102 is disposed substantially parallel to a surface on which the structure member is exposed to the outside air. In addition, the repair layer 102 can be disposed at a depth X set from a surface 111 on which the structure member is initially exposed to the outside air.

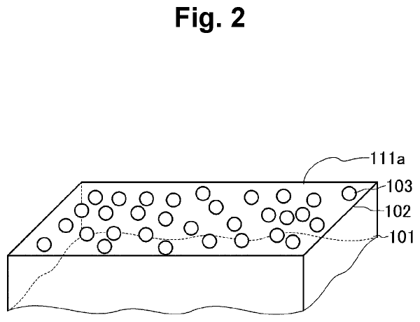

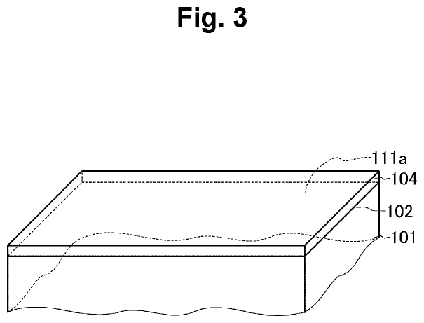

The capsule 103 is formed of a material that breaks when exposed from the base 101. As illustrated in FIG. 2, when the repair layer 102 is exposed due to the recession of the base 101, the capsule 103 is broken. As a result, as illustrated in FIG. 3, a repair film 104 due to the repairing agent released from the broken capsule 103 is formed on a surface 111a of the base 101 appearing due to the recession. By forming the repair film 104, the progress rate of corrosion deterioration of the base 101 can be suppressed. It is important that the repairing agent is formed of a material from which the repair film 104 can be formed as described above.

The size of the capsules 103 and the number of the capsules 103 in the repair layer 102 can be arbitrarily determined by the user. However, it is important that the capsule 103 is broken and the repair film 104 is formed by the enclosed repairing agent. In addition, it is important to sufficiently suppress corrosion recession of the base 101 by the repair film 104. It is important that the repair layer 102 is formed of a predetermined number of capsules 103 so that the repair film 104 is formed.

The material constituting the capsule 103 may be any material as long as it is broken by exposure, and the material can be arbitrarily determined depending on the application to be used. For example, the capsule 103 can be formed of plastic such as polyethylene terephthalate (PET) or polymethyl methacrylate (PMMA). The repair film 104 can also be formed of a biopolymer material such as a DNA film. It is important that the capsule 103 is a material that is not broken by a repairing agent to be enclosed.

The repairing agent enclosed by the capsule 103 is preferably changed depending on the type of metal material used for the base 101. For example, when the base 101 is formed of a general rolled steel material, a polyacrylic resin that blocks environmental factors caused by corrosion or a zinc rich paint expected to block the environment and have a sacrificial anode action can be employed as a repairing agent. In the case of the polyacrylic resin, after the capsule 103 is broken and performs release, curing is necessary in order to form a coating, so that the capsule 103 in which each of a main agent and a curing agent is enclosed is prepared.

In addition, in a case where copper is used for the base 101, benzotriazole useful as a copper rust inhibitor can be used as a repairing agent. As long as the metal material used for the base 101 is expected to suppress corrosion deterioration, the repairing agent is not necessarily limited to the above-described materials.

In addition, as the corrosion recession of the base 101 progresses, the built-in repair layer 102 (capsule 103) is exposed and becomes visually recognizable, and thus, it is possible to grasp the state of corrosion recession of the structure member by visually checking this state. For example, if the repair layer 102 is disposed at a set depth X from the surface 111 at which the structure member is initially exposed to the outside air, it can be grasped that the thickness of the recession of the structure member is X when the repair layer 102 is exposed and becomes visible. In addition, by constituting the repairing agent from a material having a color different from that of the base 101, the corrosion recession check by the visual inspection described above becomes easy.

The base 101 formed of the metal deteriorates due to corrosion in a natural environment. The deterioration of the base 101 is based on an oxidation-reduction reaction, in which an oxidation reaction (anode reaction) in which a metal is ionized and a reduction reaction (cathode reaction) in which dissolved oxygen or the like receives electrons progress as a series (Non Patent Literature 1 and Reference Literature 1). When the base 101 is made of iron, the corrosion reaction is as follows: “Fe→Fe²⁺+2e . . . (1), O₂+2H₂O+4e⁻→4OH⁻(2)”.

The deterioration of a metal (iron) due to corrosion is caused by a decrease in the thickness of the iron base due to ionization of iron represented by Formula (1). Therefore, if it is possible to visually measure (confirm) how much the thickness of the base 101 has decreased, it is possible to confirm whether or not the structure member is sound by visual inspection. In addition, by comparing the obtained corrosion recession data with the number of years since construction of the target equipment, the corrosion rate of the structure member (base 101) can be calculated, and it is possible to provide an indication of how many years later the target equipment should be renewed. In addition, if a large amount of measurement results can be prepared, corrosion prediction based on big data analysis becomes possible, and a corrosion map can be created on the basis of a deterioration risk for each construction year or installation environment, leading to creation of a tool useful for equipment management.

Currently, the most used method for ascertaining the deterioration state of metal equipment is visual inspection by a skilled technician. Since the deterioration state of the facility is directly checked, the deterioration can be determined as it is. However, there is a case where it is difficult to perform visual inspection depending on a structure of equipment, a sign of deterioration, and an installation place. For example, if the structure of the facility cannot be understood, it cannot be determined when the life of the target facility ends, and appropriate maintenance cannot be performed at an appropriate time in some cases.

In addition, even if the facility looks sound by visual inspection, minute perforations of a μm size are locally generated, which may seriously affect the durability of the facility. Regarding the installation place, for example, a steel tower or the like owned by a communication company is usually installed at a high place where entry is usually dangerous, and it is difficult to perform visual inspection. In addition, in the visual inspection described above, only a skilled technician can determine deterioration.

In recent years, the working population of skilled technicians engaged in inspection has been decreasing, and appropriate inspection work for a large amount of equipment laid across the country is being delayed. In addition, since 50 years will have passed since construction by 2030 in half of the facilities developed after the high economic growth period, the number of objects to be inspected is increasing year by year. It is said that it will be difficult to appropriately perform maintenance of equipment in the near future due to a decrease in the working population of skilled technicians and an increase in deteriorated equipment.

The main cause of deterioration of metal equipment is corrosion. Corrosion is a phenomenon in which the thickness of a metal material decreases, and it is known that a corrosion reaction proceeds as a series of an oxidation reaction (anode reaction) in which a metal is ionized and a reduction reaction (cathode reaction) in which water, dissolved oxygen, or the like receives electrons. Therefore, the inspection item of the metal facility is mainly measurement of the recession amount of the metal material. That is, measuring how much the metal material is reduced or scraped from the designed initial thickness is the inspection of the metal facility.

In general, however, corrosion develops as entire corrosion in which the overall thickness decreases on average. For this reason, a reference surface for measuring the corrosion recession amount cannot be set, and it is often difficult to measure the corrosion recession amount. In addition, in the case of local corrosion in which corrosion progresses at an abnormal rate only in a part of the metal material in a special environment, the amount of corrosion recession is measured on the basis of a peripheral surface in which no local corrosion occurs. However, the measured corrosion recession amount is underestimated because the corrosion recession progresses due to the entire corrosion at the same time on the surface around the location of the local corrosion. As described above, conventionally, there is a problem that the inspection of the metal structure member cannot be easily performed. In addition, depending on the method of setting the reference surface, the amount of corrosion recession may vary depending on the inspector, and a uniform inspection may not be executed.

According to the embodiment, as described above, since the state in which the thickness of the base 101 decreases can be visually measured (confirmed), unlike the above-described conventional technique, the inspection of the metal structure member can be easily performed.

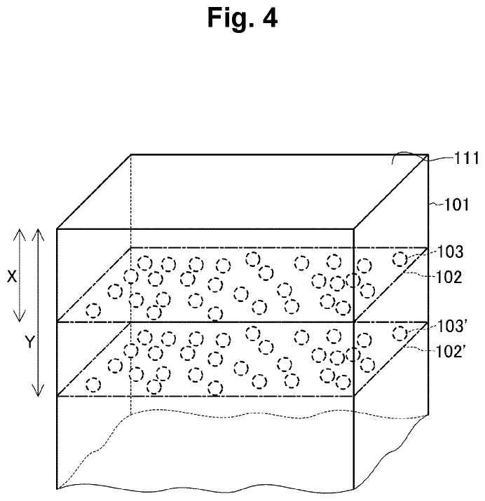

In addition, as illustrated in FIG. 4, the repair layer 102 and a repair layer 102′ can be built in the base 101. The repair layer 102′ includes a plurality of capsules 103′ dispersed on the same plane, and a liquid repairing agent is enclosed in the capsules 103′. Each of the repair layer 102 and the repair layer 102′ is disposed at a different depth from a surface on which the structure member is exposed to the outside air. For example, the repair layer 102 can be disposed at a set depth X from the surface 111 at which the structure member is initially exposed to the outside air, and the repair layer 102′ can be disposed at a depth Y deeper than the depth X from the surface 111.

As described above, by incorporating a plurality of restoration layers at different depths in the base, a repair film is formed at each of a plurality of stages in which the restoration layer is visually confirmed, and a repair effect is exhibited at a plurality of stages, so that extension of life cycle maintenance can be expected. In addition, by changing the color of the repairing agent to be used in each restoration layer, it is possible to ascertain in which stage (how much corrosion recession) the state which has been visually confirmed is.

When the corrosion deterioration of the base progresses and the repair layer is exposed, it is necessary for the user to select how the capsule is broken and to select the material constituting the capsule according to the selection. For example, if the inspection checker desires to break the capsule without going to the site when the capsule is exposed to the surface of the base, it is conceivable that the capsule be made of a material that becomes brittle in a natural environment. For example, as a material of the capsule, a biopolymer such as a DNA film in which the viscosity of the material decreases due to ultraviolet rays contained in sunlight and becomes brittle can be used.

In addition, the capsule can be directly broken when the inspection checker goes to the site and confirms that the capsule is exposed. Examples of the method for breaking the capsule include crushing the capsule by directly applying a stress or melting the capsule by applying heat. For example, by irradiating the capsule with a high power laser, the capsule can be melted by heat. Depending on the constituent material of the capsule, a suitable method as appropriate can be adopted.

As described above, according to embodiments of the present invention, since the restoration layer formed of the capsule in which the liquid repairing agent is enclosed is incorporated in the base made of metal, the maintenance of the metal structure member can be performed at low cost.

Note that, embodiments of the present invention are not limited to the embodiments described above, and it is obvious that many modifications and combinations can be made by a person having ordinary knowledge in the art within the technical idea of the present invention.

Reference Literature 1: M. Barbalat et al., “Electrochemical study of the corrosion rate of carbon steel in soil: Evolution with time and determination of residual corrosion rates under cathodic protection”, Corrosion Science, Vol. 55, pp. 246-253, 2012.

### REFERENCE SIGNS LIST

101 Base
102, 102′ Repair layer
103, 103′ Capsule
104 Repair film
111, 111a Surface

1.-6. (canceled)

7. A structure member comprising:
a base comprising a metal material; and
a repair layer disposed in the base, the repair layer comprising a plurality of capsules dispersed on a same plane, wherein each of the capsules comprises a material that is breakable upon exposure from the base, and wherein a liquid repairing agent is enclosed in each of the capsules.

8. The structure member according to claim 7, wherein, in response to breakage of a capsule of the plurality of capsules, a repair film comprising the repairing agent released from the capsule is disposed on a surface of the base where the repair layer is exposed due to recession of the base.

9. The structure member according to claim 8, wherein the repair layer is disposed at a depth set from an initial surface on which the structure member is exposed to outside air.

10. The structure member according to claim 9, further comprising a plurality of the repair layers disposed in the base, wherein each of the repair layers is disposed at a depth different from the initial surface on which the structure member is exposed to the outside air.

11. The structure member according to claim 9, wherein the repair layer is disposed substantially parallel to the initial surface on which the structure member is exposed to the outside air.

12. The structure member according to claim 11, wherein the repairing agent has a color different from a color of the base.

13. The structure member according to claim 7, wherein the repair layer is disposed at a depth set from an initial surface on which the structure member is exposed to outside air.

14. The structure member according to claim 13, further comprising a plurality of the repair layers disposed in the base, wherein each of the repair layers is disposed at a depth different from the initial surface on which the structure member is exposed to the outside air.

15. The structure member according to claim 7, wherein the repair layer is disposed substantially parallel to an initial surface on which the structure member is exposed to outside air.

16. The structure member according to claim 7, wherein the repairing agent has a color different from a color of the base.

17. A method of providing a structure member, the method comprising:
providing a base comprising a metal; and
building a repair layer in the base, the repair layer comprising a plurality of capsules dispersed on a same plane, wherein each of the capsules comprises a material that is breakable upon exposure from the base, and wherein a liquid repairing agent is enclosed in each of the capsules.

18. The method according to claim 17, wherein, following breakage of a capsule of the plurality of capsules, a repair film comprising the repairing agent released from the capsule is disposed on a surface of the base where the repair layer is exposed due to recession of the base.

19. The method according to claim 18, wherein the repair layer is disposed at a depth set from an initial surface on which the structure member is exposed to outside air.

20. The method according to claim 19, further comprising building a plurality of the repair layers in the base, wherein each of the repair layers is disposed at a depth different from the initial surface on which the structure member is exposed to the outside air.

21. The method according to claim 19, wherein the repair layer is disposed substantially parallel to the initial surface on which the structure member is exposed to the outside air.

22. The method according to claim 21, wherein the repairing agent has a color different from a color of the base.

23. The method according to claim 17, wherein the repair layer is disposed at a depth set from an initial surface on which the structure member is exposed to outside air.

24. The method according to claim 23, further comprising building a plurality of the repair layers in the base, wherein each of the repair layers is disposed at a depth different from the initial surface on which the structure member is exposed to the outside air.

25. The method according to claim 17, wherein the repair layer is disposed substantially parallel to an initial surface on which the structure member is exposed to outside air.

26. The method according to claim 17, wherein the repairing agent has a color different from a color of the base.
